(19) United States
(12) Patent Application Publication
(10) Pub. No.: US 2015/0367349 A1
(43) Pub. Date: Dec. 24, 2015

(54) PACKAGE

(71) Applicant: Sartorius Biohit Liquid Handling Oy, Helsinki (FI)

(72) Inventors: Janne LEINONEN, Kuluntalahti (FI); Sami ALT, Helsinki (FI)

(73) Assignee: SARTORIUS BIOHIT LIQUID HANDLING OY, HELSINKI (FI)

(21) Appl. No.: 14/719,490

(22) Filed: May 22, 2015

(30) Foreign Application Priority Data
Jun. 24, 2014 (FI) 20145613

(51) Int. Cl. B01L 9/00; B65D 85/62; B65D 25/10

(52) U.S. Cl. CPC B01L 9/543; B65D 25/107; B65D 85/62

(57) ABSTRACT

The present invention relates to a package for disposable pipette tips. The package comprises an essentially rectangular bottom face and four essentially rectangular side faces, and the bottom face contains one or more protrusions and/or indentations. The bottom face is adapted to receive one or more rows of disposable pipette tips stacked above each other so that each row is turned 180 degrees with respect to the row lying immediately below it.

### FIELD OF THE INVENTION

The present invention relates to a package for tapered objects, and particularly to a package for pipette tips.

### BACKGROUND OF THE INVENTION

Pipette tips are currently provided both as bulk packages and as ordered matrices, such as tip boxes or tip trays. In tip trays, pipette tips have been arranged vertically to a holder containing holes. An empty tip box can he refilled by inserting a new layer of tips, either by replacing an empty tray with a refill tray, or by inserting new tips manually from a bulk package.

A disadvantage of using tip matrices is their high price. They are also environmentally disadvantageous, since a lot of packaging material is needed for packing tips into matrix layers: typically each tip layer is separated from a neighbouring layer by means of an intermediate support layer. Thus two layers of support material are used for packing one layer of tips.

Different solutions to presenting and storing tips packed in a matrix form are known.

US 20020009398 A1 describes a rigid box that joins, bottom to bottom, two pipette-racks each having a standard matrix of pipette-receiving holes.

EP 0985451 A2 describes a pipette tip refill pack comprising several layers of pipette tips stacked upside down in a telescopic fashion. From the pack, the tips can be dispensed to a tip rack which is positioned upside down on top of the topmost tip layer.

A lower-cost alternative to tip matrices are bulk packages. Typically, bulk packages of pipette tips are plastic bags containing hundreds of tips randomly ordered. Taking tips out of a plastic hag one by one is, however, cumbersome. Therefore filling a tip box manually with hulk tips from a plastic bag is a time-intensive process.

Another disadvantage inherent in plastic bulk bags is the lack of support for tips. Typically, tips are packed into a plastic bag by simply dropping them into it. Dropping tips into the bag may cause mechanical damage to them. During transport further damage may occur as tips are not held in order but are able to move against each other and against the bag. The plastic bag is flexible and not able to support the tips during transport. In brief, the quality of tips may suffer during packaging, transport and storage in a plastic bag, which makes current bulk bags particularly unsuitable for packing very small tips, mechanically fragile tips, or tips intended for high-precision dispensing work.

Since pipette tips are randomly ordered in the currently used bulk bags, many disadvantages occur. Randomly ordered tips may he able to penetrate the plastic bag surrounding them, thus creating a risk of contamination of the tips.

Further, picking randomly ordered tips is non-ergonomic for a user, and the tips may sting a user's hand or even penetrate a user's silicone glove, which can cause a risk of contamination of the tips. By using the present invention, manual handling and picking of tips from the package is easier as the tips are arranged in a layered fashion in contrast to a randomly ordered pile: the pipette user is able to pick a tip at its wider end in a proper orientation without contaminating the narrower end of the tip. Further, picking tips from an ordered package is a quick process even if the package is almost empty.

Economical savings can be realized in terms of reduced package size and reduced package weight. The present invention utilizes the tapered, conical shape of pipette tips and allows the minimum possible space usage on package. In this way space requirement can he optimized, and each new layer of tips only requires about 60 to 70% of the total height of a tip layer.

It can be estimated that by means of the present invention, the bulk package is approximately 40% smaller in volume and 20% smaller in weight when compared to a plastic bag capable of storing a similar amount of tips. The present invention improves the cost efficiency of the product and improves the carbon footprint due to lower transportation and package material costs.

U.S. Pat. No. 5,100,021 describes a combined dispenser tray and package for serological pipettes. The tray is elongated with a stepped front wall which provides a dispensing position for sequentially dispensing individual serological pipettes.

The package shown in U.S. Pat. No. 5,100,021 does not address the problem of packing plastic, cone-shaped pipette tips in an ordered way and presenting them to a user. Plastic pipette tips differ from serological pipettes by their shape and purpose. Serological pipettes are cylindrical big tubes typically made of glass. Serological pipettes are intended for different uses and purposes than consumable plastic pipette tips. Plastic pipette tips are cone-shaped and designed to measure and transfer very accurate volumes of liquids.

The present invention is directed to overcome the above described disadvantages present in the current bulk bags. The present invention introduces a new means for packaging tips in an ordered hulk form in an environmentally sustainable way. Further, the package according to the invention introduces a robust and stable means for arranging and storing pipette tips.

### SUMMARY OF THE INVENTION

The present invention provides a package as defined in claim 1. The package comprises an essentially rectangular bottom face and four essentially rectangular side faces. The package is characterized in that the bottom face contains one or more protrusions and/or indentations, wherein the bottom face is adapted to receive one or more first-layer rows of disposable pipette tips, and wherein the package is adapted to receive one or more further-layer rows stacked onto said one or more first-layer rows, whereby each further-layer row is turned 180 degrees with respect to the row lying immediately below it.

According to an embodiment, the bottom face contains one or more protrusions or indentations with an elongated shape.

According to an embodiment, the bottom face contains one or more protrusions or indentations with a zig-zag shape.

According to an embodiment, the bottom face contains one or more protrusions that have a shape of tapered ribs.

According to an embodiment, the package is adapted to receive 960 pipette tips arranged in two adjacent stacks, each stack comprising 30 successive layers of 16-tip rows.

According to an embodiment, the package is adapted to receive 480 pipette tips arranged in two adjacent stacks, each stack comprising 15 successive layers of 16-tip rows.

According to an embodiment, the length of the protrusions and/or indentations is from 50% to 100% of the tip length.

According to an embodiment, the bottom face contains protrusions, the height of which is from 20% to 25% of the maximum tip diameter.

According to an embodiment, the bottom face contains protrusions that are separated from each other by a flat part, the width of which is from ⅔ to 3/3 of the maximum tip diameter.

According to an embodiment, the distance between the longitudinal axes of two adjacent tips is from 100% to 120% of the maximum tip diameter.

According to an embodiment, the package contains disposable pipette tips ordered in rows stacked above each other, whereby, after a first-layer row, each further-layer row has been turned 180 degrees with respect to the row lying immediately below it.

Further, the present invention provides a use of the package for storing disposable pipette tips, as defined in claim 12.

### BRIEF DESCRIPTION OF THE DRAWINGS

FIGS. 1a to 1c show a package according to an embodiment of the invention. In FIG. 1a, the package is empty. In FIG. 1b, a first layer of tips has been inserted. In FIG. 1c, a further layer of tips has been positioned above the first layer and rotated 180 degrees to follow the product shape that lies on the layer below.

FIGS. 2a to 2c show a package according to another embodiment of the invention. In FIG. 2a, the package is empty. In FIG. 2b, a first layer of tips has been inserted. In FIG. 2c, a further layer of tips has been positioned above the first layer and rotated 180 degrees to follow the product shape that lies on the layer below.

FIG. 3 shows a cross-sectional view of a package according to an embodiment of the invention. In this embodiment, the bottom face of the package contains protrusions that have a shape of tapered ribs with corner roundening.

FIG. 4 shows a cross-sectional view of a package according to another embodiment of the invention. In this embodiment, the bottom face of the package contains protrusions with a round shape that follows the tip shape.

FIG. 5a shows the embodiment of FIG. 3, illustrating the relative size of protrusions with respect to the tip size.

FIG. 5b is a closer view of FIG. 5a.

FIG. 6 shows the direction of lateral movement that can be prevented by means of the invention.

FIG. 7 illustrates tilting package.

### DETAILED DESCRIPTION OF THE INVENTION

A package according to the present invention is described in the following with reference to the drawings.

While the present invention described in the following with reference to a package for disposable pipette tips, it should be understood that the package according to the present invention is suitable for all kinds of tapered or conical objects with corresponding mechanical properties.

Preferably, the package according to the invention is adapted to receive tips arranged in linear rows. A linear row-arrangement is the most efficient with regard to space savings.

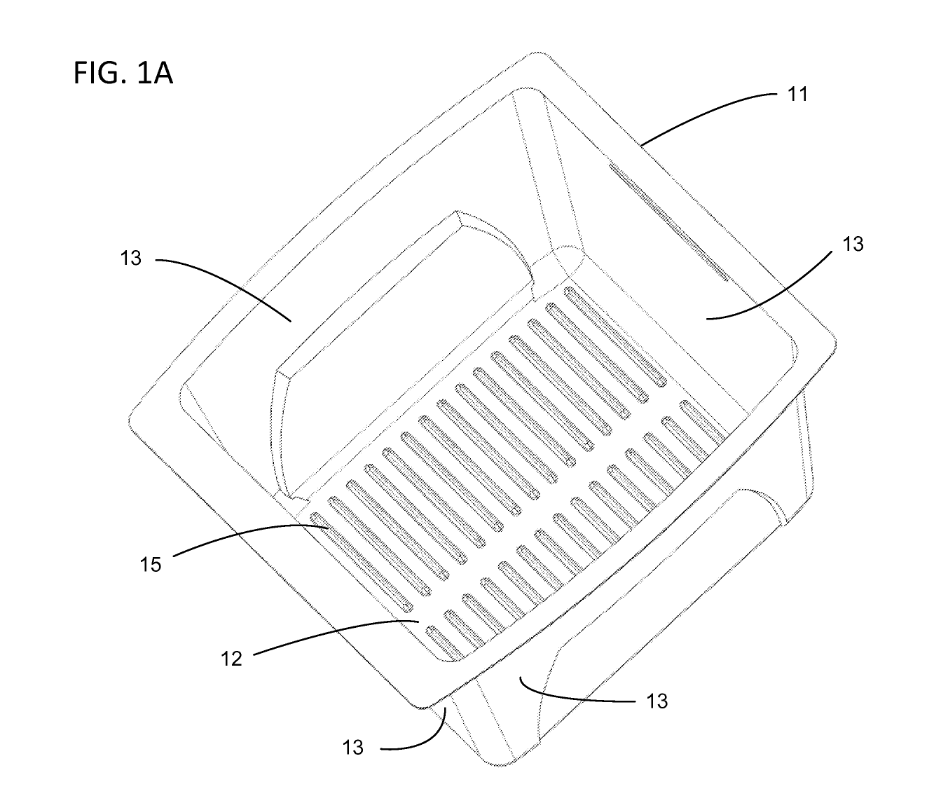

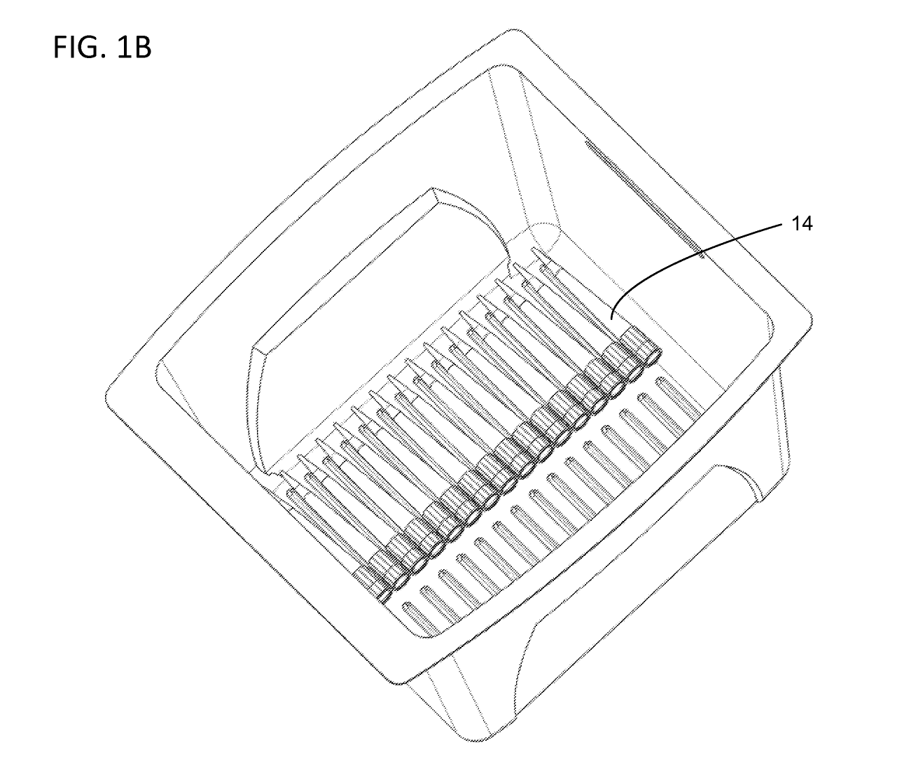

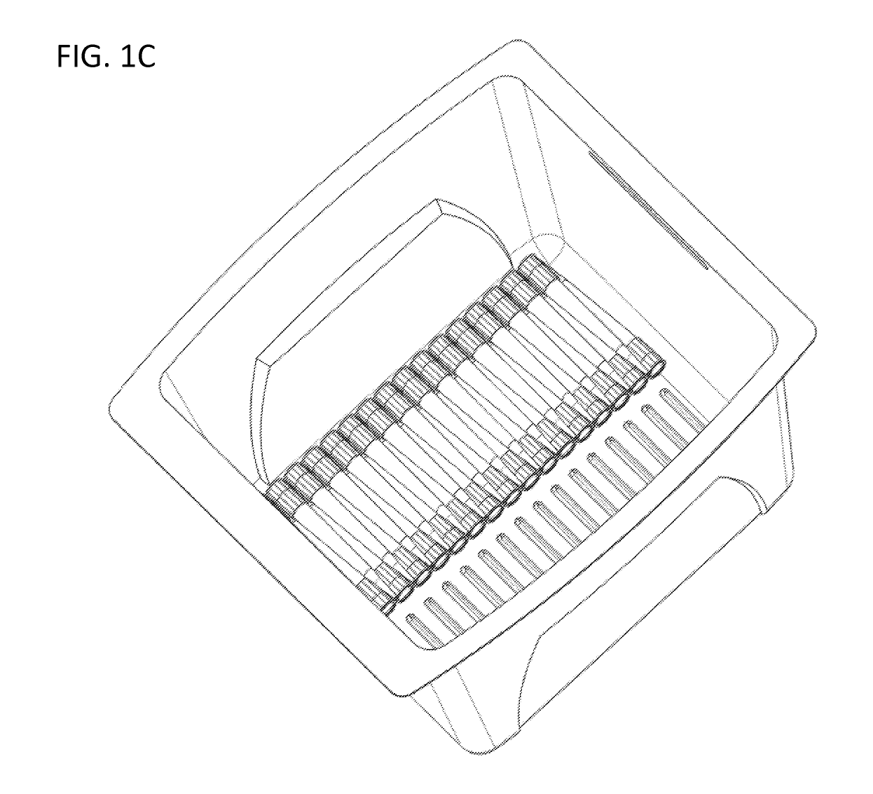

FIG. 1a shows a package 11 according to an exemplary embodiment of the invention. The embodiment is an essentially rectangular-shaped plastic box that is able to hold 960 pipette tips. The package comprises an essentially rectangular bottom face 12 and four essentially rectangular side faces 13. The tips are laid into two adjacent stacks of tips, each stack consisting of 30 layers of successive 16-tip rows. In FIG. 1a, the package is empty. The bottom face 12 of the package contains two rows of elongated protrusions 15, each row consisting of 15 protrusions adapted to support the 16 tips of the lowermost tip row.

In FIG. 1b, a bottom-layer row of tips 14 has been inserted onto the bottom face of the package. All tips of the row are oriented parallel to each other with their narrower ends pointing in the same direction.

In FIG. 1c, a second-layer row of tips has been positioned above the bottom-layer row. In the second-layer row, all tips are oriented parallel to each other with their narrower ends pointing in the opposite direction with regard to the bottom-layer row. In other words, each new layer of tips is turned 180 degrees with respect to the layer lying immediately below it.

For other applications, the indentations or protrusions that are used to support objects in the lowermost layer can be smaller or less elongated than those shown in FIG. 1a.

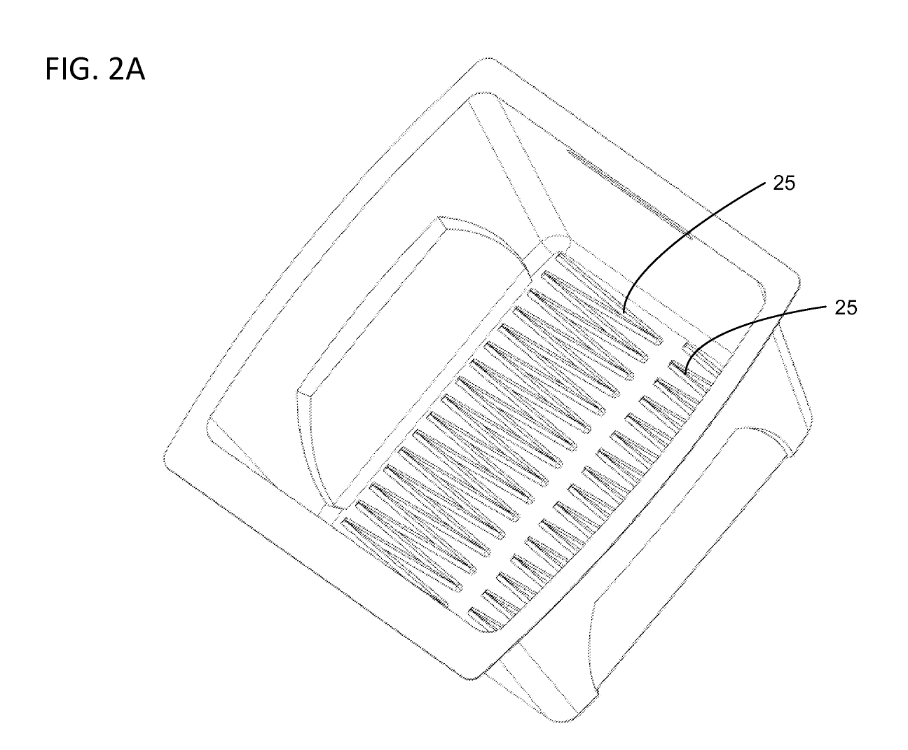

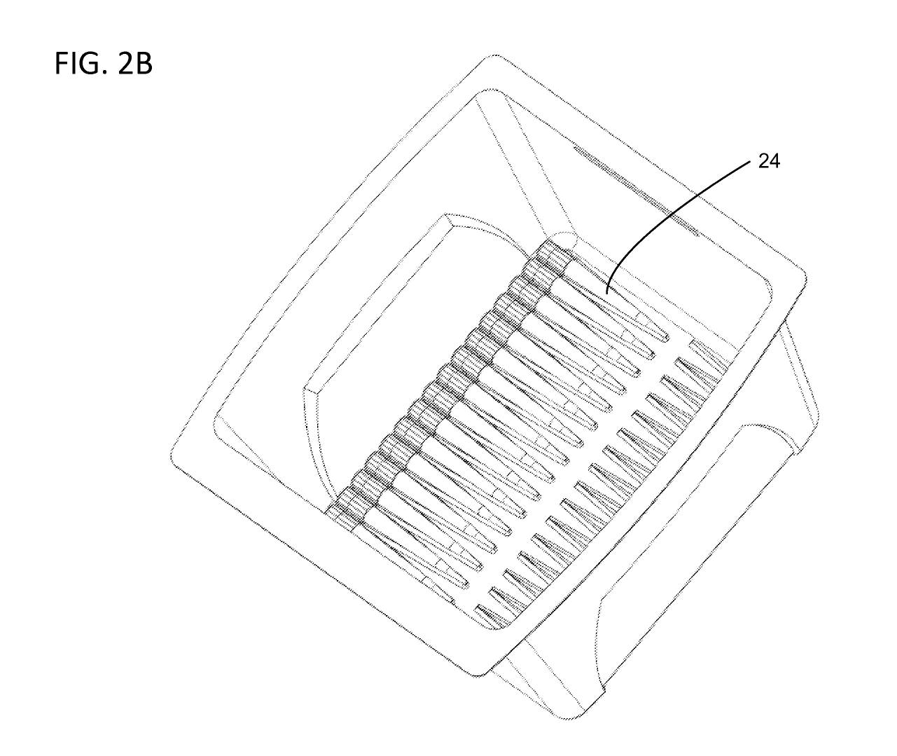

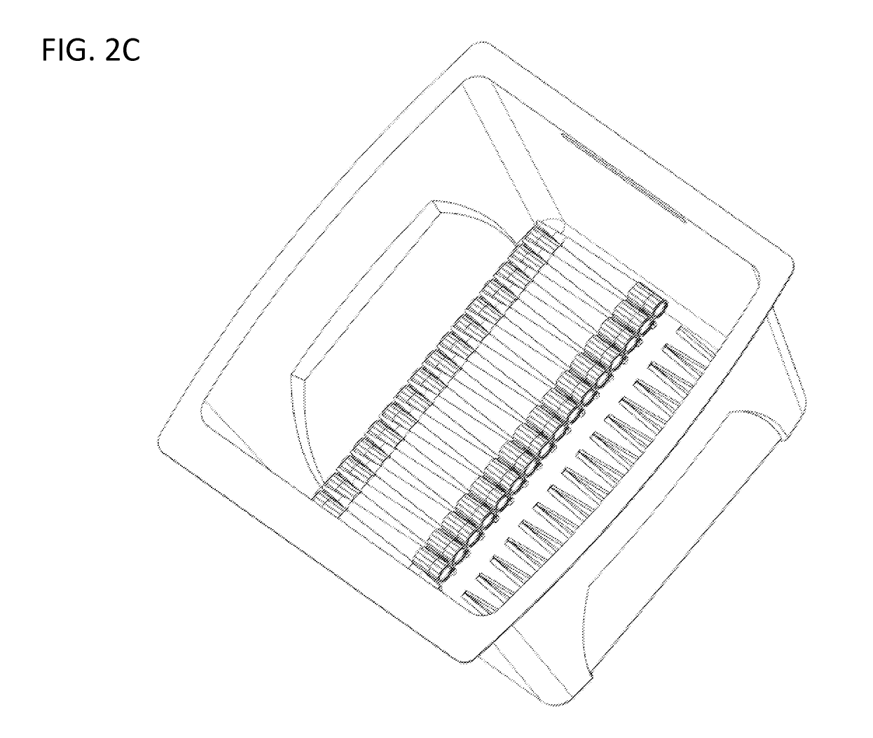

FIG. 2a shows a package according to another embodiment of the invention. In this embodiment, the bottom face of the package contains two zig-zag shaped protrusions 25 adapted to support the lowermost tip rows.

In FIG. 2b, a bottom-layer row of tips 24 has been inserted to the bottom face of the package. All tips of the row are oriented parallel to each other with their narrower end pointing in the same direction.

In FIG. 2c, a second-layer row of tips has been positioned above the bottom-layer row. In the second-layer row, all tips are oriented parallel to each other with their narrower end pointing in the opposite direction with regard to the bottom-layer row.

Preferably, the package according to the invention contains protrusions or indentations at its bottom face to support the lowermost row or rows of tips. The protrusions or indentations are preferably formed so that they are able to support tips. The shape and number of indentations or protrusions in the bottom face of the package can be varied according to the shape and number of objects to be inserted in the package.

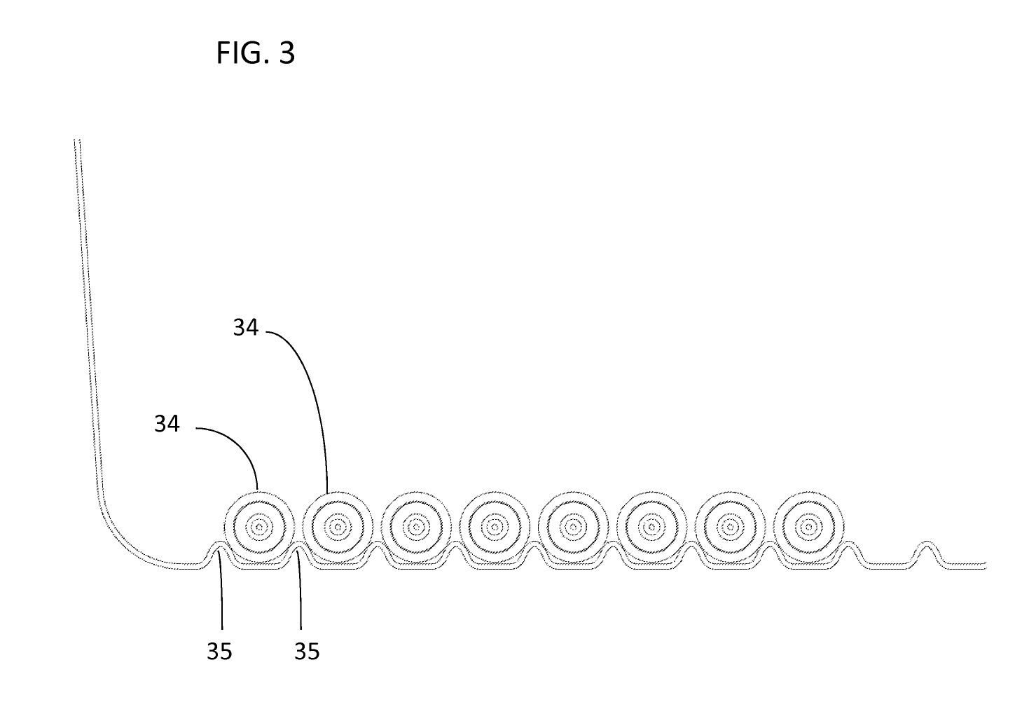

FIG. 3 shows an exemplary embodiment of the shaping of e bottom face. In this example, the bottom face of the package contains protrusions 35 that have a shape of tapered ribs with corner roundening and that are designed to separate adjacent tips 34 from each other and to hold them in place.

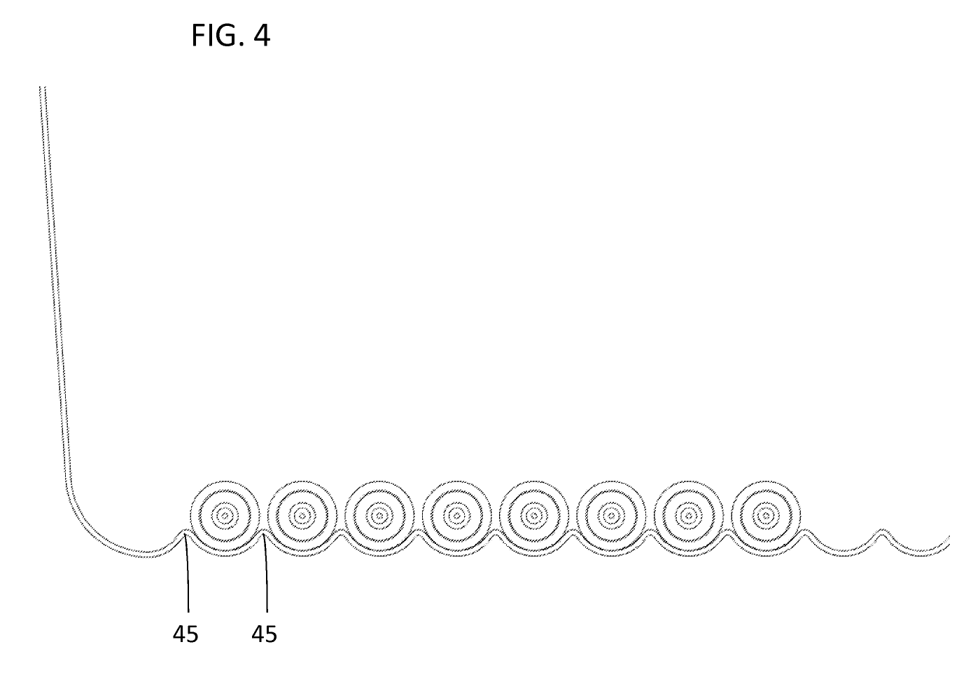

FIG. 4 shows another exemplary embodiment of the shaping of the bottom face. In this example, the bottom face of the package contains protrusions 45 with a round shape that follows the tip shape.

The size of protrusions or indentations is preferably adjusted so that their height and length and separation from each other is determined by the dimensions of the tips.

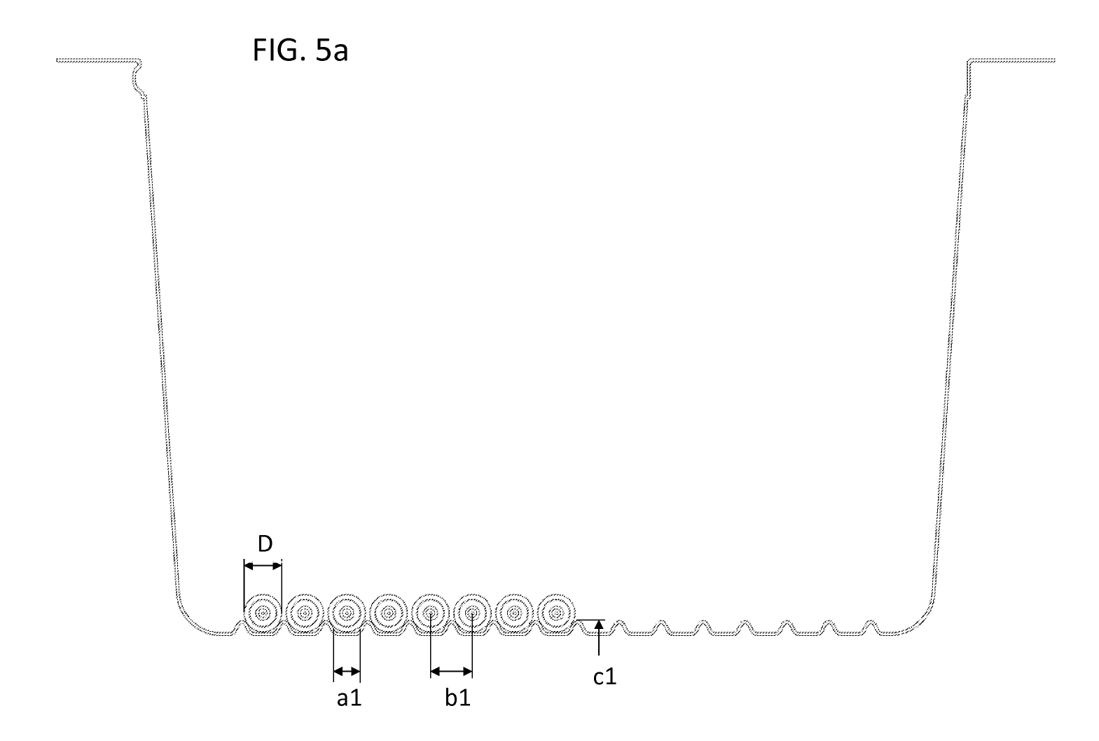

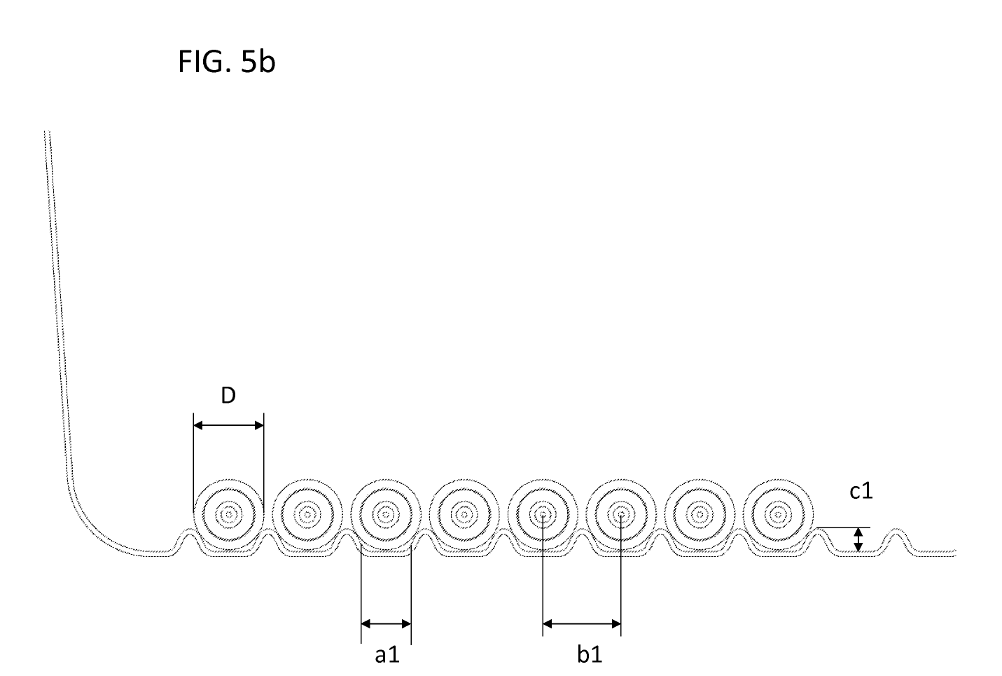

FIGS. 5a and 5b illustrate the relative dimensions of protrusions and tips according to an embodiment. The maximum diameter of the tips, that is the diameter as measured from the wider end of the tip, is denoted with D. The distance between the edges of two adjacent protrusions, that is the width of the flat part separating two adjacent protrusions, is denoted with a1. The distance between the longitudinal axes of two adjacent tips is denoted with b1. The height of a protrusion is denoted with c1.

For example, the length of protrusions or indentations may be from 50% to 100% of the total length of the tips to be inserted.

The distance a1 is preferably smaller than the maximum tip diameter D. Most preferably, the distance a1 is from ⅔ to 3/3of the maximum tip diameter D.

Preferably, the distance b1 is from 1.0D to 1.2D, that is from 100% to 120% of the maximum tip diameter D.

Preferably, the protrusion height c1 is from 20% to 25 of the maximum tip diameter D.

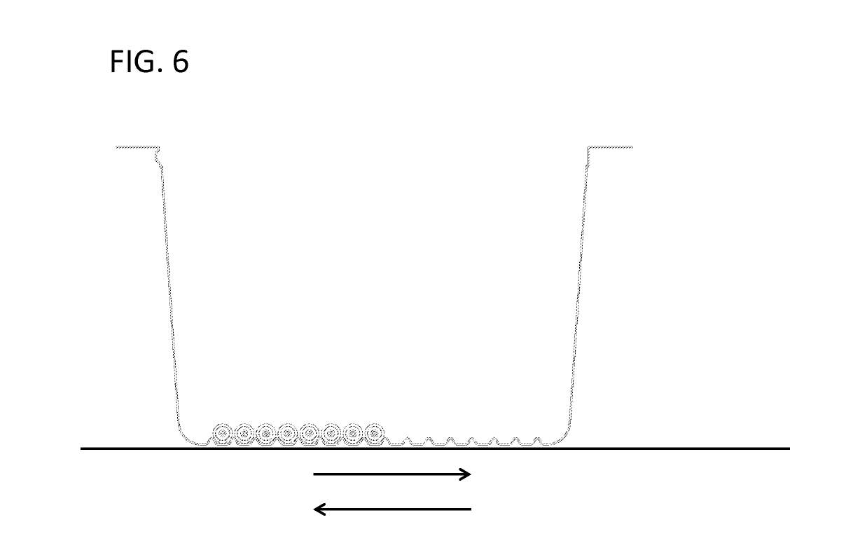

For certain applications, the bottom face may be essentially flat, without any significant shaping. The presence of protrusions or indentations is, however, preferable for such objects that are difficult to pack due their particular shape and size and the inherent problems associated with static electricity. The presence of protrusions or indentations can be advantageous in preventing undesired lateral movement of the tips to be stored. FIG. 6 denotes such lateral movements with arrows.

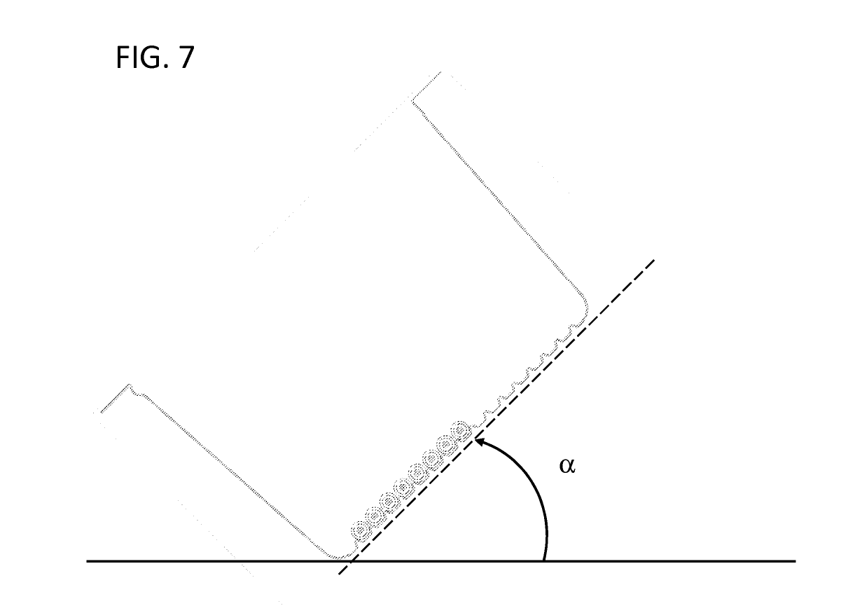

We have observed that protrusions with a height of approximately 20% to 25% of the maximum tip diameter D, i.e. when c1 is between 0.20D and 0.25D, are able to support tips in such a way that tilting the package up to an angle of 45° is possible without disturbing or collapsing the ordered layout of the tips. FIG. 7 shows a package in a tilted configuration. The tilt angle of the package is denoted with α.

Preferably, the protrusions or indentations form an integral part of the package bottom face. Alternatively, the protrusions or indentations can be realized by using an additional removable bottom layer having protrusions or indentations with a shape adapted to support tips.

In the embodiments shown in FIGS. 1a-c and 2a-c, the package is adapted to receive tips in two adjacent stacks. It should be understood, however, that other configurations are also possible. According to an embodiment, the package may be adapted to receive only one stack of tips, whereby a stack consists of multiple superimposed rows of tips.

According to a preferable embodiment, the package according to the invention is adapted to receive 960 tips ordered in 2 stacks. Preferably each stack consists of 30 successive 16-tip rows.

According to another preferable embodiment, the package according to the invention is adapted to receive 240 tips ordered in 1 stack. Preferably the stack consists of 15 successive 16-tip rows.

According to a still another preferable embodiment, the package according to the invention is adapted to receive 480 tips ordered in 2 stacks. Preferably each of the two stacks consists of 15 successive 16-tip rows.

According to an embodiment, the package according to the invention is adapted to receive tips ordered in 16-tip rows stacked above each other in one or more adjacent stacks.

Other tip layouts and stacking configurations are also possible,

In the case of embodiments wherein the package is adapted to receive multiple stacks of tips, each stack is preferably separated from adjacent stacks by a small spacing so that tips residing in adjacent stacks do not overlap or interact.

The package according to the invention may be adapted to receive tips of any size or type. For example, the package may be adapted to receive ordinary tips, wide bore (WB) tips, or filter tips.

According to an embodiment, the package is adapted to receive 0.5-200 μl tips, that is tips that are suitable for pipetting liquid volumes in the range from 0.5 μl to 200 μl . In this embodiment, the package preferably holds 960 tips.

According to another embodiment, the package is adapted to receive 5-350 μl tips, that is tips that are suitable for pipetting liquid volumes in the range from 5 μl to 350 μl. In this embodiment, the package preferably holds 960 tips.

According to another embodiment, the package is adapted to receive 10-1000 μl tips, that is tips that are suitable for pipetting liquid volumes in the range from 10 μl to 1000 μl. In this embodiment, the package preferably holds 480 tips.

According to another embodiment, the package is adapted to receive 50-1200 μl tips, that is tips that are suitable for pipetting liquid volumes in the range from 50 μl to 1200 μl. in this embodiment, the package preferably holds 480 tips.

According to another embodiment, the package is adapted to receive 0.5-10 μl tips, that is tips that are suitable for pipetting liquid volumes in the range from 0.5 μl to 10 μl.

According to another embodiment, the package is adapted to receive tips with a maximum volume of 5 ml.

According to another embodiment, the package is adapted to receive tips with a maximum volume of 10 ml.

Preferably, the general form of the package is a rectangular cuboid.

The package according to the present invention is made of any suitable material. It is preferably made of a plastic material, for example a recyclable plastic material or a plastic biomaterial.

Preferably, the package contains a cover. The cover is preferably designed so that covered packages can be easily stacked on top of each other for transport and/or storage. Preferably, the cover is joined to the rest of the package via a hinge. Preferably, a top surface of the cover is recessed to allow stacking.

1. Package, comprising an essentially rectangular bottom face (12) and four essentially rectangular side faces (13), characterized in that the bottom face contains one or more protrusions (15, 25, 35, 45) and/or indentations, wherein the bottom face is adapted to receive one or more first-layer rows of disposable pipette tips (14, 24, 34), and wherein the package is adapted to receive one or more further-layer rows stacked onto said one or more first-layer rows, whereby each further-layer row is turned 180 degrees with respect to the row lying immediately below it.

2. Package of claim 1, wherein the bottom face contains one or more protrusions or indentations with an elongated shape (15).

3. Package of claim 1, wherein the bottom face contains one or more protrusions or indentations with a zig-zag shape (25).

4. Package of claim 1, wherein the bottom face contains one or more protrusions that have a shape of tapered ribs (35).

5. Package of claim 1, adapted to receive 960 pipette tips arranged in two adjacent stacks, each stack comprising 30 successive layers of 16-tip rows.

6. Package of claim 1, adapted to receive 480 pipette tips arranged in two adjacent stacks, each stack comprising 15 successive layers of 16-tip rows.

7. Package of claim 1, wherein the length of the protrusions and/or indentations is from 50% to 100% of the tip length.

8. Package of claim 1, wherein the bottom face contains protrusions, the height of which is from 20% to 25% of the maximum tip diameter.

9. Package of claim 1, wherein the bottom face contains protrusions that are separated from each other by a flat part, the width of which is from ⅔ to 3/3 of the maximum tip diameter.

10. Package of claim 1, wherein the distance between the longitudinal axes of two adjacent tips is from 100% to 120% of the maximum tip diameter.

11. Package of claim 1, containing disposable pipette tips ordered in rows stacked above each other, whereby, after a first-layer row, each further-layer row has been turned 180 degrees with respect to the row lying immediately below it.

12. Use of a package of claim 1 for storing disposable pipette tips.
